(19) United States
(12) Patent Application Publication
(10) Pub. No.: US 2025/0041837 A1
(43) Pub. Date: Feb. 6, 2025

(54) PROCESS FOR PRODUCING NANOFLAKES FROM G-C3N4/METAL COMPOSITE MATERIAL

(71) Applicant: HydroSolid GmbH, Wilhelmsburg (AT)

(72) Inventors: Merkur SMAJLAJ, Langenhagen (DE); Michael RENZ, Himberg (AT)

(21) Appl. No.: 18/717,745

(22) PCT Filed: Dec. 2, 2022
(86) PCT No.: PCT/AT2022/060424

§ 371 Date: Jun. 7, 2024

(30) Foreign Application Priority Data
Dec. 10, 2021 (AT) A50989/2021

(51) Int. Cl. B01J 27/24; B01J 35/39; B01J 35/45; B01J 35/50; B01J 37/08; B01J 37/34; C01B 3/00; C25B 11/037

(52) U.S. Cl. CPC B01J 27/24; B01J 35/39; B01J 35/45; B01J 35/50; B01J 37/08; B01J 37/343; C01B 3/0078; C25B 11/037

(57) ABSTRACT

The present invention relates to a method for producing g-C₃N₄/metal composite nanoflakes comprising the following steps: (A) providing a starting material comprising or consisting of FePO₄, urea and polyacrylnitrile, wherein the starting material is in the form of a powder having particles having an average particle size of less than 100 nm, (b) dispersing the starting material in a solvent, wherein the solvent is water, (c) removing the solvent to form a premix containing the starting material, (d) heating the premix and pyrolyzing the premix at a pyrolyzing temperature between 200° C. and 700° C., preferably between 400° C. and 600° C. to form a bulk g-C₃N₄ metal composite material, (e) treating the bulk g-C₃N₄ metal composite material with ultrasound to form g-C₃N₄ metal composite material nanoflakes.

The present invention relates to a method for producing nanoflakes from a g-C₃N₄/metal composite material according to the features of the independent patent claim 1. The invention further relates to nanoflakes obtainable by such a method, to a hydrogen storage material and to a photocatalyst, a photoelectrocatalyst and an electrocatalyst, which contain nanoflakes according to the invention.

Graphitic carbon nitride, also referred to as g-C₃N₄, is a polymer material that, according to the state of the art, is used in various fields of application, for example for heterogeneous catalysis applications or as a storage material for molecular hydrogen. Pure g-C₃N₄ is a metal-free compound whose properties are customized and improved by the formation of composite materials with metals or metal compounds.

Materials based on g-C₃N₄ are already known in the state of the art. The paper “Facile Production of a Fenton-Like Photocatalyst by Two-Step Calcination with a Broad pH Adaptability” by Siyang Ji et al. (nanomaterials, 2020) describes g-C₃N₄ nanoflakes, in which iron is incorporated into the g-C₃N₄. CN 104437643 A describes an impregnation of g-C₃N₄ with ferrous substances. CN 110479345 A describes g-C₃N₄ quantum dots carried on Fe-oxide flakes. CN 110429277 A describes a sulphur-doped g-C₃N₄ material without going into detail about the exact properties of the iron it contains. The paper “Facile synthesis of graphitic carbon nitride/chitosam/Au nanocomposite: A catalyst for electrochemical hydrogen evolution” by Atefeh Nasri et al. (International Journal of Biological Macromolecules, 2020) describes a g-C₃N₄ gold nanocomposite. CN 112156662 A discloses nanofibres.

However, the performance characteristics of known g-C₃N₄ metal composite materials are insufficient, particularly for the storage of hydrogen and the photocatalytic production of hydrogen and oxygen from water. In particular, the storage capacity for hydrogen and/or the achievable hydrogen production rate are factors of known g-C₃N₄/metal composites that require improvement.

It is therefore an object of the present invention to overcome the disadvantages of known g-C₃N₄/metal composite materials. In particular, one object of the present invention is to provide a g-C₃N₄/metal composite material, which is improved with respect to at least one of the following performance characteristics: storage capacity for hydrogen, adsorption capacity for hydrogen, hydrogen production rate, achievable electrical current density in photoelectrocatalysis and electrolysis of water.

In the context of the present invention, it was surprisingly found that these and other objects can be achieved in particular by a composite material produced by a method according to the invention.

The present invention relates to a method for producing g-C₃N₄/metal composite material nanoflakes comprising several steps.

Optionally, a step (a) having the following features is provided: providing a starting material comprising or consisting of an iron compound, a g-C₃N₄ precursor material and a polymer. The iron compound may be iron(III) phosphate. The g-C₃N₄ precursor material may be urea (CH₄N₂O). The polymer may be polyacrylonitrile. In particular, the starting material is a powder whose particles have an average particle size of less than 100 nm.

It was found that the use of polyacrylonitrile in the starting material allows nanoflakes with particularly favourable properties to be obtained. Without being limited to this theory, it is assumed that the polyacrylonitrile forms a template that significantly influences the geometric parameters, in particular length, width, shape, and orientation, of the nanoflakes produced.

Optionally, a further advantageous technical effect of polyacrylonitrile is that cyclisation of the polyacrylonitrile may take place as part of the process, whereby a conductor polymer is formed, which provides the g-C₃N₄ material with particular stability, in particular with regard to chemical, thermal and mechanical properties. For example, the use of polyacrylonitrile can provide the composite material with improved flame, fire and heat resistance, which is particularly advantageous in applications involving hydrogen, as the potential formation of oxyhydrogen gas mixtures and burning hydrogen gas cannot cause the composite material to ignite.

Optionally, a step (b) having the following features is provided: dispersing the starting material in a solvent, wherein the solvent is in particular water. Optionally, the water has a boiling temperature in step (b). Optionally, this step results in incomplete dissolution of the starting material in the solvent.

A better dispersion, in particular achievable by the smallest possible diameter of the particles of the starting material, improves the subsequent reaction to g-C₃N₄, for example with regard to yield and kinetics.

Optionally, a step (c) having the following features is provided: removing the solvent to form a premix containing the starting material.

Optionally, a step (d) having the following features is provided: heating the premix obtained in step (c) and pyrolyzing the premix at a pyrolosis temperature between 200° C. and 700° C., preferably between 400° C. and 600° C. to form a bulk-g-C₃N₄/metal composite material.

“Bulk-g-C₃N₄/metal composite material” in the context of the present invention refers in particular to a material with a coherent, layered structure in which optionally a plurality of layers is superimposed.

Optionally, a step (d) having the following features is provided: Treating the bulk-g-C₃N₄/metal composite material with ultrasound to form g-C₃N₄/metal composite material nanoflakes.

The ultrasound treatment causes in particular an exfoliation of the g-C₃N₄/metal composite material, wherein nanoflakes are formed from the bulk material. Optionally, the layered structure of the bulk material is fractured, whereby the nanoflakes are formed. Another advantageous effect of ultrasound treatment may be a better distribution of the metal between the g-C₃N₄ layers, which then may optionally act as stabilising spacers.

Optionally, the ultrasound used for the treatment in step (e) has a frequency between 20 kHz and 100 kHz. Optionally, the energy input by the ultrasound in step (d) is at least 0.25 W per g of the bulk g-C₃N₄/metal composite material.

In the context of the present invention, “nanoflakes” refer in particular to particles that have an external dimension precisely in the nanoscale range, i.e. between 1 nm and 100 nm.

The nanoflakes produced by the method according to the invention or the nanoflakes according to the invention are in particular nanoporous, i.e. they have pores with a dimension in the sub-100 nm range. The nanoporosity is achieved in particular by dispersion and optional grinding and by ultrasound treatment in step (b).

Optionally, it is provided that the amount of the iron compound in step (a) is between 1.0 wt % and 20 wt % with respect to the total amount of the starting material.

Optionally, it is provided that the dispersion in step (b) is carried out at a temperature between 80° C. and 100° C., preferably between 90° C. and 100° C. This allows the starting material to partially dissolve, which optionally improves the completeness of the reaction to g-C₃N₄.

Optionally, it is provided that the dispersion in step (b) is carried out using ultrasound treatment. For example, the treatment may be carried out using an ultrasound rod, which is inserted into the dispersion. Optionally, the ultrasound used for treatment in step (b) has a frequency between 20 kHz and 100 kHz. Optionally, the energy input by the ultrasound in step (d) is at least 0.25 W per ml of the dispersion. Improved dispersion may be achieved by ultrasound treatment, which optionally improves the completeness of the reaction to g-C₃N₄.

Optionally, the dispersion in step (b) takes at least 1 hour, in particular approximately 2 hours.

Optionally, it is provided that the heating rate during heating to the pyrolysis temperature in step (d) is greater than or equal to 5° C./min.

Optionally, it is provided that the pyrolysis temperature in step (d) is approximately 450° C. As a result, iron(III) phosphate can be obtained in the layers of the produced g-C₃N₄/metal composite material, when iron(III) phosphate is used in the starting material.

Optionally, it is provided that the pyrolysis temperature in step (d) is approximately 550° C. As a result, iron(III) oxide can be obtained in the layers of the produced g-C₃N₄/metal composite material, when iron(III) phosphate is used in the starting material.

Optionally, the pyrolysis in step (d) takes at least 4 hours, in particular approximately 5 hours.

Optionally, it is provided that the following further step is provided after step (d): reducing the iron contained in the g-C₃N₄/metal composite material. Optionally, the reduction is achieved by treating the composite material with hydrogen. Depending on the extent of the reduction, the iron may be converted into iron (II) ions or elemental iron.

Optionally, it is provided that a further metal compound is added in step (a), wherein the further metal compound is selected from an aluminium, lithium, magnesium, titanium, nickel, platinum, palladium and vanadium compound or any mixture of these compounds.

The specific properties of the composite material may be customized by adding a further metal compound.

Optionally, it is provided that the amount of the further metal compound in step (a) is between 0.5 wt % and 5.0 wt %, preferably about 1.0 wt %, with respect to the total amount of the starting material.

Optionally, it is provided that the pyrolysis in step (d) takes place in an inert gas atmosphere, in particular in a nitrogen atmosphere. This prevents oxidation of the components.

Optionally, it is provided that in step (a) the components of the starting material are ground, optionally in a ball mill, in order to achieve a particle size of less than 100 nm.

It was found that g-C₃N₄/metal composite nanoflakes can also be obtained by an alternative method involving several steps:

Optionally, a step (a′) having the following features is provided: providing g-C₃N₄ by pyrolysis of a mixture of a g-C₃N₄ precursor material and a polymer at a pyrolysis temperature between 200° C. and 700° C., preferably between 400° C. and 600° C. The g-C₃N₄ precursor material is in particular urea. The polymer is in particular polyacrylonitrile. Preferably, the mixture is a powder having particles of an average particle size of less than 100 nm.

Optionally, the temperature during pyrolysis and step (a′) is approximately 500°. Optionally, in step (a′) the mixture is heated to the pyrolysis temperature at a heating rate of approximately 5° C./min. Optionally, the pyrolysis in step (a′) takes at least 4 hour, in particular approximately 5 hours.

Optionally, a step (b′) having the following features is provided: mixing the g-C₃N₄ obtained in step (a′) with an iron compound, wherein the iron compound is selected from iron oxide, iron sulphide, iron phosphide, iron nitride or any mixture thereof, to obtain a premix. In the context of the present invention, it was found that by using iron oxide, iron sulphide, iron phosphide or iron nitride as the iron compound, analogous results to those obtained with iron(III) phosphate can only be obtained if already prepared g-C₃N₄ is provided. Optionally, only a formation of g-C₃N₄ clusters around the iron compounds would otherwise take place, whereby no material according to the invention could be obtained.

Optionally, a step (c′) having the following features is provided: grinding the premix obtained in step (b′) to a particle size of less than 100 nm. Optionally, this may be achieved by ball milling.

Optionally, a step (d′) having the following features is provided: treatment of the ground premix at a temperature between 400° C. and 600° C. to form g-C₃N₄/metal composite nanoflakes.

In particular, the temperature in step (d′) is about 550° C., whereby an iron(III) oxide composite material can be obtained.

Optionally, the treatment in step (d′) causes the nanoflakes to straighten and defects to heal.

Optionally, step (d′) is carried out in an inert gas atmosphere, in particular in a nitrogen atmosphere.

The two methods both deliver g-C₃N₄/metal composite material nanoflakes as the end product, which have comparable properties. The methods can therefore be understood as alternative methods.

Optionally, the invention also relates to nanoflakes obtained and/or obtainable by a method according to the invention. The method steps provide the nanoflakes with special properties that distinguish them from nanoflakes known in the prior art. In particular, by using the method according to the invention, a composite material structure is created which allows a particularly homogeneous distribution of iron on the surface of g-C₃N₄ flakes.

Optionally, it is provided that the composite material comprises pores, wherein the pores have an average pore size of less than 100 nm.

Optionally, it is provided that g-C₃N₄-nanoflakes are provided, on the surface of which iron and/or the iron compound is carried, wherein the iron and/or the iron compound is presented in particulate form with a particle diameter of less than 100 nm.

Optionally, the invention also relates to a hydrogen storage material containing or consisting of g-C₃N₄/metal composite nanoflakes according to the invention. Optionally, the invention relates to the use of g-C₃N₄/metal composite nanoflakes according to the invention as hydrogen storage material.

Optionally, the invention relates to a method for storing hydrogen comprising loading g-C₃N₄/metal composite material nanoflakes according to the invention with hydrogen gas. Optionally, loading takes place at a pressure of greater than 10 bar, preferably less than 25 bar.

Optionally, desorption of the hydrogen is achieved by heating the loaded composite material, for example to a temperature between 60° C. and 100° C.

The influence of an electric field is able to enhance the loading. The voltage of the electric field is optionally more than 1000 V.

Optionally, the invention also relates to a photocatalyst containing or consisting of g-C₃N₄/metal composite material nanoflakes according to the invention. Optionally, the invention relates to the use of g-C₃N₄/metal composite material nanoflakes according to the invention as photocatalyst.

Optionally, the invention also relates to a photoelectrocatalyst containing or consisting of g-C₃N₄/metal composite material nanoflakes according to the invention. Optionally, the invention relates to the use of g-C₃N₄/metal composite material nanoflakes according to the invention as photoelectrocatalyst.

Optionally, the invention further relates to an electrocatalyst containing or consisting of a-CN/metal composite material nanoflakes according to the invention. Optionally, the invention relates to the use of g-C₃N₄/metal composite material nanoflakes according to the invention as electrocatalyst.

Since the g-C₃N₄/metal composite material according to the invention is a semiconductor whose band gap is changed by way of doping etc., it is catalytically active. This is why it can also be used as a photocatalyst, electrocatalyst or photoelectrocatalyst, next to the storage of hydrogen.

Optionally, the invention relates to a method for the photoelectrocatalysis of water and for the production of hydrogen comprising the introduction of g-C₃N₄/metal composite nanoflakes according to the invention into water. Optionally, the g-C₃N₄/metal composite nanoflakes introduced into water are irradiated with a radiation source, which optionally is a UV/V is source. Optionally, the radiation source emits electromagnetic radiation having a wavelength between 200 nm and 1000 nm.

Further optional features of the present invention become apparent from the patent claims, the figures and the description of the embodiments.

In the following, the present invention will be explained in detail with reference to exemplary embodiments.

In the figures:

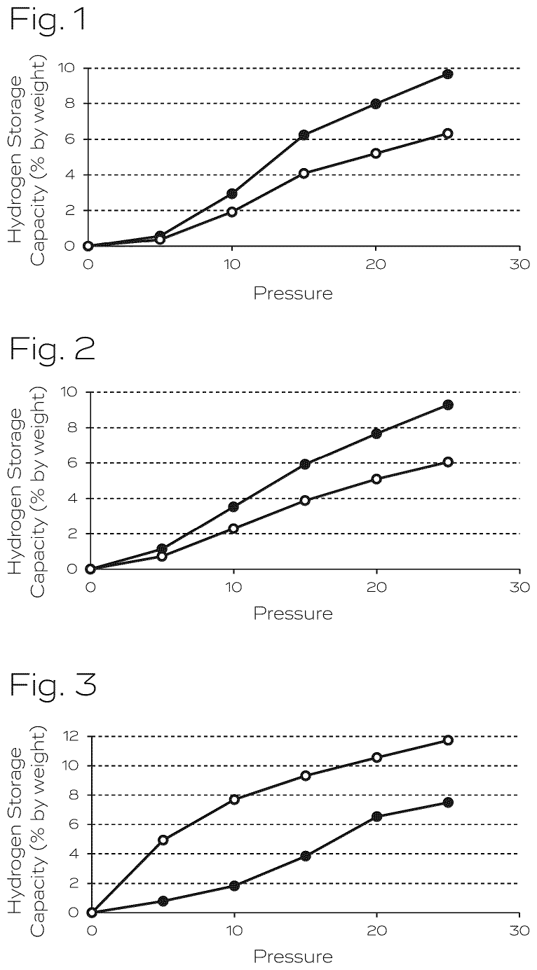

FIG. 1 shows the hydrogen storage capacity of a g-C₃N₄/metal composite material according to a first embodiment;

FIG. 2 shows the hydrogen storage capacity of a g-C₃N₄/metal composite material according to a second embodiment; and

FIG. 3 shows the hydrogen storage capacity of a g-C₃N₄/metal composite material according to a third embodiment with voltage-assisted loading.

### EMBODIMENT 1

The first embodiment shows the production of a g-C₃N₄/iron composite material, whereby a mixture of 2 wt % iron(III) phosphate, 95 wt % urea and 3 wt % polyacrylonitrile is used as the starting material. The components are mixed and ground in a ball mill for about 45 min at 600 rpm to form a starting material having an average particle size of less than 100 nm.

The resulting starting material is dispersed in as little water as possible using a disperser and an ultrasonic bath at a temperature of approximately 95° C.

When the dispersion is complete, the water is removed, and the remaining material is pyrolized in a N₂ atmosphere at a pyrolysis temperature of approximately 550° C. for approximately 5 hours. Until the pyrolysis temperature is reached, the heating rate is approximately 5° C./min.

A layered bulk g-C₃N₄/composite material is obtained, wherein iron(III) oxide is included between the layers.

Then the produced bulk g-C₃N₄/composite material is exfoliated by ultrasound treatment to form g-C₃N₄/metal composite nanoflakes.

The compound can be used as a hydrogen storage material. At up to 25 bar, a hydrogen storage capacity of 9.2 wt % can be achieved at around −20° C. and a hydrogen storage capacity of 6.1 wt % at around 25° C. A substantially complete desorption takes place at approximately 80° C.

FIG. 1 shows the hydrogen storage capacity of the g-C₃N₄/metal composite material produced according to the first embodiment as a function of pressure and in comparison between approximately −20° C. (black circles) and approximately 25° C. (white circles).

### EMBODIMENT 2

The second embodiment shows the production of a g-C₃N₄/iron-titanium composite material, wherein a mixture of 1% wt % iron(III) phosphate, 95 wt % urea and 3 wt % polyacrylonitrile with the further addition of 1 wt % titanium dioxide is used.

The further method steps are carried out in the same way as in the first embodiment.

Ti-doped g-C₃N₄/Fe composite nanoflakes are obtained, which can be used as hydrogen storage material. At up to 25 bar, a hydrogen storage capacity of 9.6 wt % can be achieved at around −20° C. and a hydrogen storage capacity of 6.3 wt % at around 25° C. A substantially complete desorption takes place at approximately 80° C.

FIG. 2 shows the hydrogen storage capacity of the g-C₃N₄/metal composite material produced according to the second embodiment as a function of pressure and in comparison between approximately −20° C. (black circles) and approximately 25° C. (white circles).

### EMBODIMENT 3

The third embodiment shows the production of a g-C₃N₄/iron-titanium composite material, wherein a mixture of 3 wt % iron(III) phosphate, 90 wt % urea and 5 wt % polyacrylonitrile with the further addition of 1 wt % titanium dioxide is used as starting material. The components are mixed and ground in a ball mill for about 45 min at 600 rpm to form a starting material with an average particle size of less than 100 nm.

The resulting starting material is dispersed in as little water as possible using a disperser and an ultrasound bath at a temperature of approximately 95° C.

When the dispersion is complete, the water is removed, and the remaining material is pyrolized in a N₂ atmosphere at a pyrolysis temperature of about 450° C. for about 5 hours. Until the pyrolysis temperature is reached, the heating rate is approx. 5° C./min.

A layered bulk g-C₃N₄/metal composite material is obtained, wherein iron(III) phosphate is included between the layers.

Then the produced bulk g-C₃N₄/composite material is exfoliated by ultrasonic treatment to form g-C₃N₄/metal composite nanoflakes.

The compound can be used as a hydrogen storage material. At up to 25 bar, a hydrogen storage capacity of 7.4 wt % can be achieved.

If the composite material is loaded under the additional influence of an electric field with a voltage of around 1400 V, a hydrogen storage capacity of 11.7 wt % can be achieved.

FIG. 3 shows the hydrogen storage capacity of the g-C₃N₄/metal composite material produced according to the third embodiment as a function of pressure, comparing the capacity without voltage-assisted loading (black circles) and with voltage-assisted loading (white circles).

### EMBODIMENT 4

The g-C₃N₄/metal composite material with Ti and Fe produced according to the third embodiment can—like any other composite materials according to the invention—be used as an electrophotocatalyst in the production of hydrogen and oxygen from water.

If a dispersion of the g-C₃N₄/metal composite material in water is irradiated using a UV/Vis source, a hydrogen production rate of around 35.3 mmol/(g*h) can be achieved. During the generation of hydrogen, an overvoltage of about 96 mV can be measured. The electrical current density is approximately 2.67 mA/cm.

1. A method for producing g-C₃N₄/metal composite material nanoflakes, the method comprising the following steps:
a. providing a starting material comprising or consisting of an iron compound, a g-C₃N₄ precursor material and a polymer,
i. wherein the iron compound is FePO₄.
ii. wherein the g-C₃N₄ precursor material is urea, and
iii. wherein the polymer is polyacrylonitrile,
wherein the starting material is in the form of powder with particles having an average particle size of less than 100 nm,
b. dispersing the starting material in a solvent, wherein the solvent is water,
c. removing the solvent to form a premix containing the starting material,
d. heating the premix and pyrolyzing the premix at a pyrolysis temperature between 200° C. and 700° C., preferably between 400° C. and 600° C. to form a bulk g-C₃N₄/metal composite material.
e. treating the bulk-g-C₃N₄/metal composite material with ultrasound to form g-C₃N₄/metal composite material nanoflakes.

2. The method according to claim 1, characterised in that the amount of the iron compound in step (a) is between 1.0 wt % and 20 wt % with respect to the total amount of the starting material.

3. The method according to claim 1, characterised in that dispersing in step (b) is carried out at a temperature between 80° C. and 100° C., preferably between 90° C. and 100° C., and optionally with ultrasound treatment.

4. The method according to claim 1, characterised in that the heating rate during heating to the pyrolysis temperature in step (d) is greater than or equal to 5° C./min.

5. The method according to claim 1, characterised in that the pyrolysis temperature in step (d) is approximately 450° C., or in that the pyrolysis temperature in step (d) is approximately 550° C.

6. The method according to claim 1, characterised in that the method comprises the following further step after step (d):
reducing the iron in the g-C₃N₄/metal composite material.

7. The method according to claim 1, characterised in that in step (a) a further metal compound is added, wherein the further metal compound is selected from an aluminium, lithium, magnesium, titanium, nickel, platinum, palladium, vanadium compound or any mixture of these compounds.

8. The method according to claim 7, characterised in that the amount of the further metal compound in step (a) is between 0.5 wt % and 5.0 wt %, preferably approximately 1.0 wt %, with respect to the total amount of the starting material.

9. The method according to claim 1, characterised in that the pyrolysis in step (d) takes place in an inert gas atmosphere, in particular in a nitrogen atmosphere.

10. A g-C₃N₄/metal composite material in the form of nanoflakes obtainable by a method according to claim 1, wherein g-C₃N₄/nanoflakes are provided on the surface of which iron and/or the iron compound is carried, wherein the iron and/or the iron compound is in the particulate form with a particle diameter of less than 100 nm.

11. The composite material according to claim 10, comprising pores having an average pore size of less than 100 nm.

12. A hydrogen storage material comprising or consisting of g-C₃N₄/metal composite material according to claim 10.

13. An electrocatalyst for water electrolysis comprising or consisting of g-C₃N₄/metal composite material according to claim 10.

14. A photocatalyst for water electrolysis comprising or consisting of g-C₃N₄/metal composite material according to claim 10.

15. A photoelectrocatalyst for water electrolysis comprising or consisting of g-C₃N₄/metal composite material according to claim 10.

16. (canceled)

17. (canceled)
